(19) United States
(12) Patent Application Publication
(10) Pub. No.: US 2003/0154136 A1
(43) Pub. Date: Aug. 14, 2003

(54) Price tags in data

(75) Inventors: Ran Bittmann, Tel Aviv (IL); Alexander Grinshpun, Tel Aviv (IL); Rafael Kiel, Modi'in (IL); Yonathan Malachi, Ness Ziona (IL)

Correspondence Address: BROWDY AND NEIMARK, P.L.L.C., 624 NINTH STREET, NW, SUITE 300, WASHINGTON, DC, 20001-5303, US

(73) Assignee: MSAFE INC., Wilmington, DE

(21) Appl. No.: 10/074,229

(22) Filed: Feb. 14, 2002

(51) Int. Cl. G06F 17/60

(52) U.S. Cl. 705/26; 705/1

(57) ABSTRACT

Incorporated in data is a price tag including price information about one or more service/product for trading by a customer. A charging agent associated with one or more network operators servicing the customer reads the price tag and if warranted, charges or credits the account(s) of the customer with the network operator(s) in accordance with the price information. In some cases the traded product(s) includes at least part of the data in which the price tag is incorporated.

### FIELD OF THE INVENTION

The present invention relates to, inter alia, trading services/products via communication networks.

In the related art, a merchant who wishes to sell a service/product to a customer via a communication network, such as the Internet, requests payment information from the customer. The customer in turn provides debit/credit card information to the merchant. The merchant waits for approval from the debit/credit card company before delivering the service/product. This procedure closely matches the procedure for selling a service/product to a customer in a store, where the customer provides the merchant with a credit/debit card for payment and the credit/debit card is verified prior to permitting the customer to take possession of the service/product.

U.S. Pat. No. 6,029,151 to Nikander discloses an electronic payment transaction system in a node joining a first telecommunications network and a second telecommunications network comprising an electronic wallet means for converting electronic money transaction messages into conventional transactions and an electronic payment intercepting means for redirecting to said electronic wallet means at least a part of electronic money transaction messages arriving from the first telecommunications network and addressed to users in the second telecommunications network. Specifically, the internet service provider (ISP) intercepts electronic payment requests sent by a merchant to the client, uses electronic money on behalf of the client and charges the payments to the telephone bill of the client. It should be noted that notwithstanding the interception by the ISP, the overall payment protocol including a payment request, is not different than the payment protocol for a transaction with no ISP interception.

Such an approach suffers from at least two drawbacks. First, the ISP appropriates all the problems associated with the electronic money transfer that were previously faced by the client. For example, the ISP is responsible for care of all the technical details in obtaining and managing the different forms of electronic money. Second, there is no variation of payment protocols in anticipation of ISP interception, and therefore the relationship between the ISP and the merchant is relegated to a level similar to the relationship between the merchant and the client.

Some data, such as certain types of content data, which are transmitted over a communication network, have an inherent worth. In some cases, the data is currently transmitted free of charge due to the difficulty and/or inconvenience of billing for the data and/or ensuring receipt of the data.

### SUMMARY OF THE INVENTION

In the following description and claims the term “registering” or “registered” in relation to an account means to denote the recording of a trade-related debit or credit into a customer account.

According to the present invention there is provided a method for trading at least one service or product between a merchant and a customer, including: the merchant, incorporating a price tag in data that relates to the tradable service or product and that is to be transmitted from the merchant to the customer, the price tag including price information for the at least one service or product and being incorporated in anticipation of the price information being registered if the trade is completed in a customer account with a network operator that provides access for the customer to a communication network; transmitting the data via the communication network; and the network operator or a charging utility associated therewith, intercepting the price tag and if the trade is completed, registering the price information in the customer account.

The price tag is preferably formatted according to an acceptable standard.

According to the present invention there is further provided a method for evaluating whether to allow a charge or a credit for at least one service or product in a trade between a merchant and a customer, including: receiving data that relates to the traded service or product and that includes a price tag transmitted via a communication network, the price tag including price information for the at least one service or product and the price tag having been incorporated in the data in anticipation of the price information being charged or credited to a customer account with a network operator providing access for the customer to the communication network; reading the price tag; evaluating whether the customer account can support a charge or a credit for a sum of money represented by the price information; and if the customer account cannot support the charge for the sum represented by said price information, not allowing the trade to be completed.

According to the present invention there is still further provided a method for trading at least one service/product between a merchant and a customer, including: the merchant, incorporating a price tag in data that relates to the tradable service or product and that is to be transmitted from the merchant to the customer, the price tag including price information for the at least one service or product and being incorporated in anticipation of the price information being registered if the trade is completed in a customer account with a network operator that provides access for the customer to a communication network; transmitting the data via the communication network; a charging agent associated with said network operator intercepting the price tag, and recording a charge or a credit according to said price information in the customer account; a billing system associated with the network operator receiving the recorded charge or credit and settling the recorded charge or credit with the merchant.

According to the present invention there is provided a system for pricing a service or product tradable between a merchant and a customer, including: an incorporator utility for incorporating a price tag in data that relates to the tradable service or product to be transmitted from the merchant to the customer through a communication network, the price tag including price information for the at least one service or product and being incorporated in anticipation of charging or crediting a customer account with a network operator that provides access for the customer to the communication network, the charging or crediting being based on the price information and occurring if the trade is completed.

According to the present invention there is further provided a system for deciding whether to allow a charge for a service or product in a trade between a merchant and a customer, including: a reader for intercepting and reading a price tag that is incorporated in data relating to the traded service or product, the data being transmitted via a communication network, the price tag including price information for the traded service or product and having been incorporated in the data in anticipation of charging or crediting a customer account with a network operator providing access for the customer to the communication network based on the price information; and an evaluator for evaluating if said customer account can support a charge or a credit for a sum of money represented by said price information.

According to the present invention there is provided a method for selling content from a merchant of the content to a customer, including: the merchant incorporating a price tag in data that includes the content, the price tag including price information for said content and being incorporated in anticipation of the price information being charged to a customer account with a network operator that provides access for the customer to a communication network; transmitting the data via the communication network; and the network operator or a charging utility associated therewith, intercepting the price tag and if the sale is completed, registering the price information in the customer account.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is a block diagram of a network for trading services/products, according to a preferred embodiment of the present invention;

FIG. 1B is a block diagram of a network for trading services/products, according to another preferred embodiment of the present invention;

FIG. 2 is a block diagram of a charging agent, according to a preferred embodiment of the present invention;

FIG. 3 illustrates the fields included in a price tag, according to a preferred embodiment of the present invention;

FIG. 4 is a flowchart of a method for trading services/products according to a preferred embodiment of the present invention;

FIG. 5 illustrates the values of a sample price tag, according to a preferred embodiment of the present invention; and

FIG. 6 illustrates a sample record generated by a charging agent, according to a preferred embodiment of the present invention.

### DESCRIPTION OF SPECIFIC EMBODIMENTS

A preferred embodiment of the present invention is of price tags incorporated in data. Specifically, the price tags allow an account of a customer with a network operator to be charged or credited if warranted.

The principles and operation of incorporated price tags according to the present invention may be better understood with reference to the drawings and the accompanying description. All examples given below are non-limiting illustrations of the invention described and defined herein.

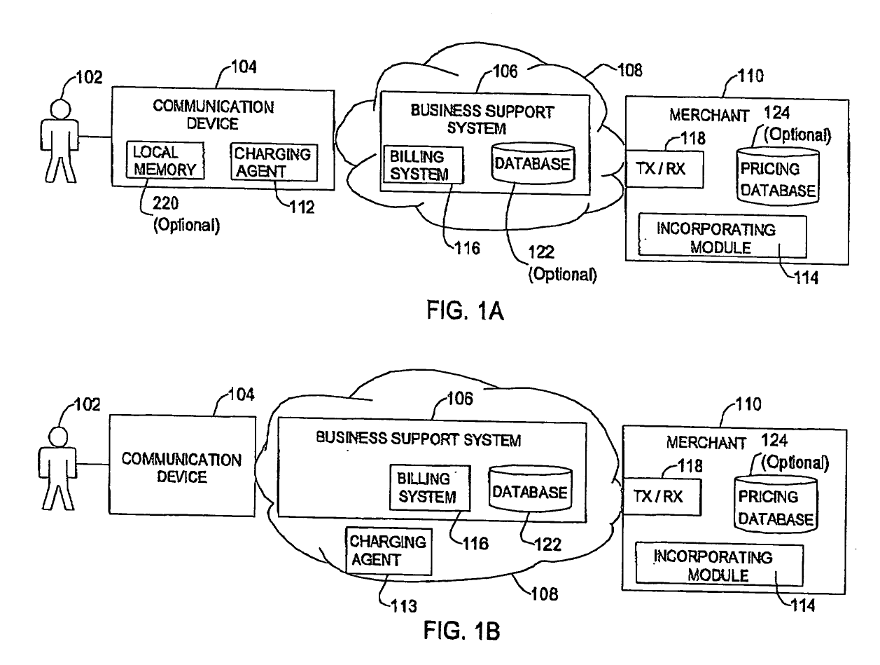

Referring now to the drawings, FIG. 1A and FIG. 1B illustrate networks of tho current invention, according to two preferred embodiments. A customer 102 uses a communication device 104 to connect to a communication network 108 in order to communicate with a merchant 110. In the discussion below, the term “merchant” includes any entity whose business is buying and selling a service or product or any representatives of such an entity, for example agents, sales people, licensees, franchisees, etc. The term “merchant” also includes a module (hardware and/or software) that performs some or all of the (automated) functions of buying and selling for the entity or a representative of the entity. The product in some cases may be content data.

Merchant 110 includes appropriate means 118 for transmitting to/receiving from communication network 108. Examples of means 118 include LAN Interface Cards (NIC), access routers, modems (V.90, ISDN, ADSL), antennas, etc. Merchant 110 also includes an incorporating nodule 114, for example a software program, for incorporating price tags into data to be transmitted. Merchant 110 optionally also includes a pricing database 124 located in a server which includes pricing information.

Typically some or all of the automated functions of merchant 110 are implemented in the form of a server. In some cases, server 110 may be associated with a web site which can be accessed by customer 102, provided communication device 104 includes or is coupled to a web browser or another program utilizing web access.

Examples of communication devices 104 include wireless devices (cellular phones, pagers, etc.), Public Switched Telephone Network (PSTN) devices (fax machines, telephones, etc.), computers, Personal Digital Assistants (PDA's) etc. Examples of communication networks 108 include cellular, PSTN, Internet, Intranet, a combination of any of the above technologies, etc. As an example of a combination, cellular telephone operators may provide a gateway, for example a Wireless Application Protocol (“WAP”) gateway, between the cellular telephone network and the Internet. As another example, access from the Internet to a cellular telephone network can be provided through a push proxy server.

The communication infrastructure includes all components of communication network 108 that are involved in the provision of communication service to communication device 104 using the appropriate technology. For example in the case of a cellular telephone system, the communication infrastructure includes the base stations of the various cells, a cellular telephone switching office that has all the phone connections of the cellular communication devices that communicate with a base station that is linked to the cellular telephone switching office, central system that coordinates activity and supports central offices, etc. In case of a PSTN telephone system, the communication infrastructure includes the cabling, the central office switch, etc. In the case of the Internet, the communication infrastructure includes the backbone routers, access routers, name servers, end nodes, etc.

With the evolution of telephone networks (initially cellular but also PSTN) to packet switching technology in the network backbone, an increase in the number of IP networking devices (e.g., routers) in corresponding communication networks 108 can be expected.

If the communication is via a particular communication network 108 using a combination of technologies, the communication infrastructure includes components corresponding to the combination.

The communication infrastructure can be thought of as “belonging” to one or more network operators (either by ownership, rental, or other suitable arrangement). Therefore in order to access the communication infrastructure, customer 102 establishes an account with the corresponding network operator(s). Different types of accounts are possible, for example prepaid accounts or accounts where payments for incurred charges (debits) or credits are due periodically (sometimes termed postpaid accounts). Examples of network operators include: cellular operators, PSTN operators, Internet service providers (ISPs), etc. For example in order to access the Internet, customer 102 may be required to have an account with both a PSTN operator and an ISP.

In the discussion below the network operator that provides access for customer 102 to the communication infrastructure, and which is responsible for charging or crediting customer 102 for the sums of money represented by the price tags is termed “charging party”. It should be understood that the term “charge” or “debit” may in some cases be a zero amount. For example, in some cases, the network operator of tho last segment of network 108 is the charging party. As another example, a charging agent 112 associated with the charging party is located in a communication device 104, which is in communication with and controlled by a billing system 116 (where a client account is maintained). As yet another example, in some cases, where the physical access network is provided by a local exchange carrier (LEC) and the Internet connection by the ISP, the ISP may be the charging party. As yet another example, in some cellular networks there is an MVNO (mobile virtual network operator) that provides all the cellular services while relying on (renting out) the physical network of another operator. In this situation, the MVNO is often the charging party and the operator of the physical network of backbone and antennas is invisible to the user. It should be evident that if more than one network operator provides access for customer 102, one or more of these network operators can be selected as the charging party (i.e. the singular form of the term includes the possibility of more than one network operators together functioning as the charging party). The charge party has settling arrangements with merchant 110 so that money owed by customer 102 or money owed to customer 102 is ultimately given to or taken from merchant 110 (possibly on an aggregate basis with money from/for other customers 102).

A business support system 106 is associated with We charging part. Typically business support system 106 is part of the information technology facilities of the charging party included in business support system 106 are billing system 116 and a database 122 for storing customer account information (for example account balance (prepaid accounts), account balance due (postpaid accounts), credit rating, credit line and/or account rules). In some embodiments, database 122 can be included in billing system 116. Billing system 116 bills customer 102 for any recorded charges or credits in the customer account, unless the account is a prepaid account where collection is made in advance. Billing system 116 may also bill merchant 110 based on the credits or debits registered and/or billed to customer 102. The billing of customer 102 or merchant 110 can be done through communication network 108 or using any other suitable means, for example regular mail. Billing system 116 also collects money from customer 102 either on a prepaid basis or based on billed charges or credits. Billing system 116 also settles the sums of money owed to/owed from merchant 110 with merchant 110 (based an debits/credits to the customer account). Billing system 116 typically, but not exclusively, includes software running on one or more servers.

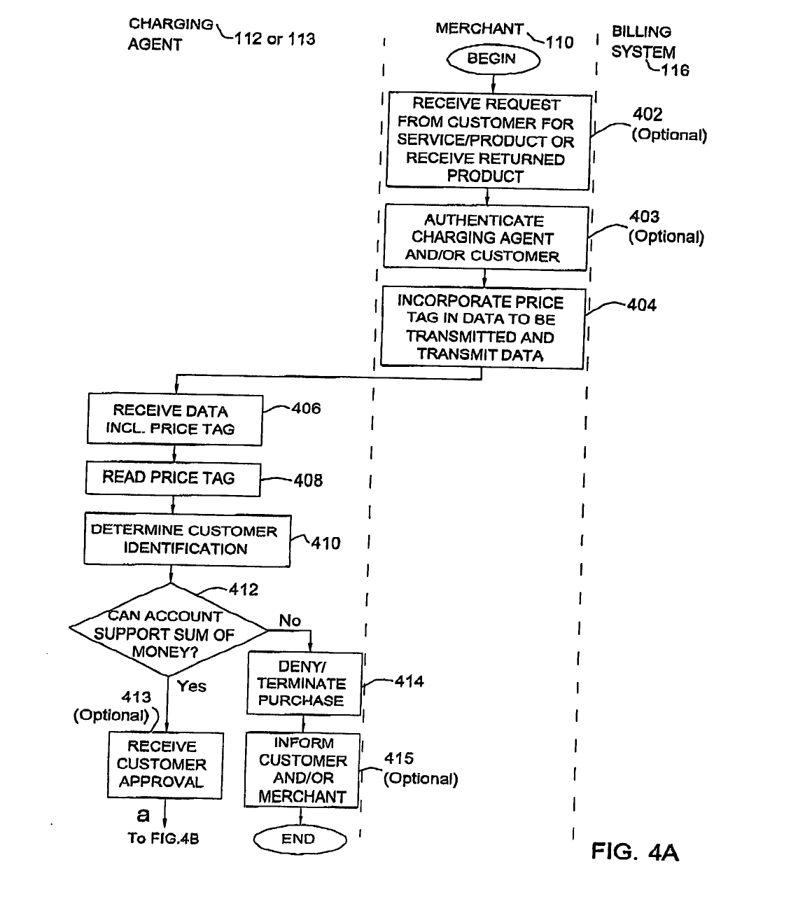

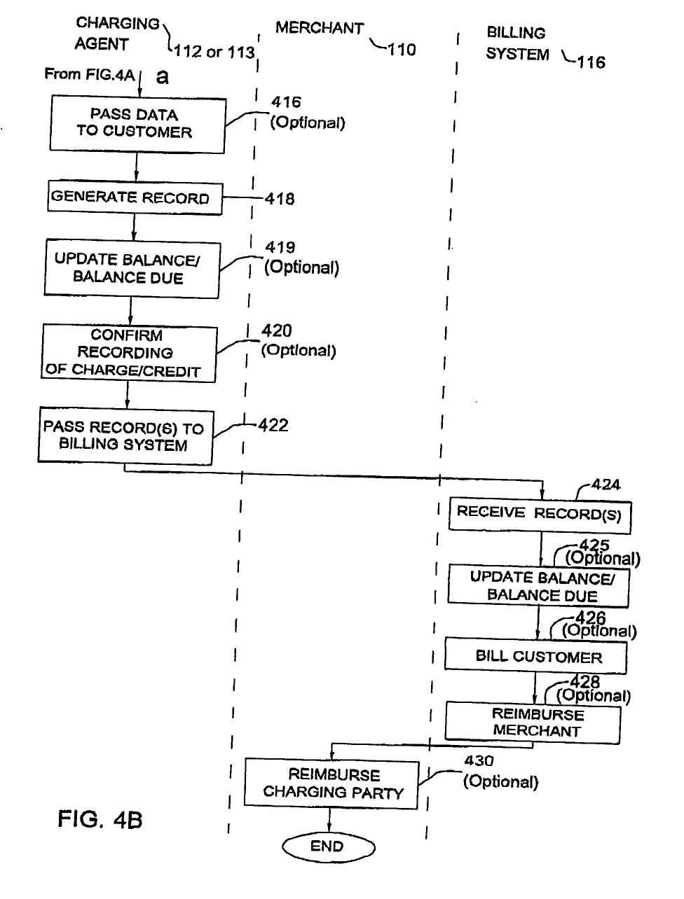

Also associated with the charging party is a charging agent 112 or 113. In FIG. 1A, charging agent 112 is included in or coupled to communication device 104. In FIG. 1B a charging agent 113 is included in or coupled to the communication infrastructure so as to be able to observe traffic, for example embedded in a switch or a router. In some cases, having charging agent 112 included in or coupled to communication device 104 allows improved performance over the configuration of FIG. 1D, by reducing the usage of central system resources. If charging agent 112 is included in or coupled to a particular communication device 104, then charging agent 112 handles the trading process (see FIG. 4 below) of customers 102 which use that particular communication device 104. Alternatively, if charging agent 113 is included in or coupled to the communication infrastructure, charging agent 113 handles the trading process (see FIG. 4 below) of a plurality of customers 102. It should be evident that in the latter case, charging agent 113 is typically configured to handle simultaneous trading processes of a plurality of customers 102. As noted above, charging agent 112 or 113 is in communication with and under control of billing system 116 and in some embodiments a part of agent 112 or 113 may even be included in or coupled with business support system 106 (not shown).

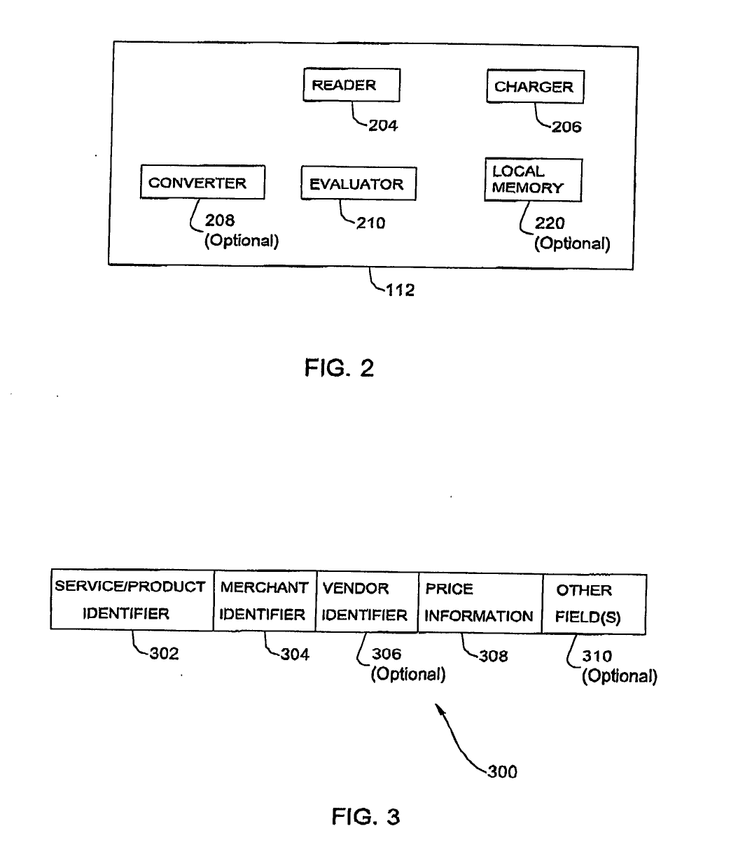

FIG. 2 illustrates an embodiment of charging agent 112. Charging agent 112 includes a reader 204 for receiving data sent by merchant 110 and reading the price tag incorporated in the data. In some cases reader 204 may intercept data directed to customer 102, and in other cases reader 204 may receive data directed to charging agent 112. Charging agent 112 also includes an evaluator 210 for evaluating whether an account of customer 102 with the charging party can support the sum of money (charge or credit) represented by the price tag. Also included in charging agent 112 is a charger 206 for recording a charge or credit to an account of customers 102 with the charging party (i.e. generating a record of the charge or credit), if warranted. Charger 206 also optionally updates account balances or balances due for any recorded charges or credits, as will be explained further below with reference to step 419.

It should be evident that in general the evaluation of whether an account can support a sum of money, which is a credit or a zero amount, yields a affirmative response. The evaluation of whether an account can support a non-zero debit may depend on the account balance, account balance due, credit line and/or credit rating of customer 102 with the charging party and/or other subjective criteria. For example, the account balances of some customers 102 may be allowed to go slightly below zero. As another example, the account balance due for a particular customer 102 may not be allowed to exceed a limit compatible with the credit rating of that particular customer 102. Preferably the criteria are formulated in a set of rules, accessible by evaluator 210.

Optionally a converter 208 is also included in charging agent 112 for converting the sum of money represented by the price tag to the local currency (i.e. currency of country of residence of customer 102).

Typically but not exclusively, reader 204, evaluator 210, charger 206 and optional converter 208 are implemented in software, although implementation in hardware is also possible.

Optionally, in some preferred embodiments, charging agent 112 includes a local memory 220 for storing information about the account of customer 102 with the charging party (for example account balance, balance due, credit rating, credit line and/or account rules). Optionally in some other preferred embodiments, local memory 220 is outside of charging agent 112 and separately included in or coupled to communication device 104. Local memory 220 can be for example a flash memory. The option of storing a balance in local memory 220 is especially useful for a prepaid customer 102 where the balance is pre-purchased. The usage of a local memory 220 also lessens the communication between charging agent 112 and billing system 116.

It should be evident that in some preferred embodiments a part of charging agent 112 may be included in or coupled to the communication infrastructure and/or to business support system 106. For example, reader 204, converter 208, and charger 206 may be included in or coupled to communication device 104, and evaluator 210 may be included in or coupled to business support system 106, e.g. being part of the billing server of the system (not shown). Also assume for this example that database 122 is used for storing account information and that no local memory 220 is used for storing account information. Therefore in this example, reader 204 communicates over communication network 108 with evaluator 210 to send data from the price tag. Evaluator 210 receives relevant account information from database 122 for use in evaluating whether an account of customer 102 with the charging party can support the sum of money represented by the price tag. Evaluator 210 then communicates over communication network 108 with charger 206 to send the evaluation results.

If at least part of charging agent 112 is inside or coupled to communication device 104, that part of charging agent 112 may be linked to the receiver/transmitter means, for example the modem, of communication device 104 so as to be able to communicate with the communication infrastructure and/or business support system 106. In addition, the link may be configured so as to cause all data received by communication device 104 to be intercepted by reader 204 of charging agent 112 prior to becoming available to customer 102.

If charging agent 113 embedded in the communication infrastructure is employed, similar functions to those included in charging agent 112 may be included in it, mutatis mutandis.

If necessary, the transfer of information between physically separate parts of module 112 or 113, between physically separate parts of system 116 and/or between module 112 or 113 and billing system 116 which are physically separate is preferably performed automatically in a manner not controlled or interruptible by customer 102 so as to ensure the integrity of the transferred information. The transfer over communication network 108 can be, for example, periodically, or during an off-peak period. The exchange of data may involve standard handshake protocols and will typically be encrypted and authenticated. The exchange of data is preferably secure, using for example protocols such as SSL/TLS (Secure Socket Layer/Transport Layer Security), IPsec (IP Security), or WTLS (Wireless Transport Layer Security). The price information itself is preferably transmitted in a secured format as well (using encryption and/or digital signature or hashing).

In some preferred embodiments, the functions of elements in FIG. 1 and/or 2 may be divided into fewer or more elements. For example, the functions of charged agent 112 may be divided into fewer or more elements. The division into elements chosen for the description is for ease of explanation.

As mentioned above, merchant 110 incorporates price tags into the data stream, which is then transmitted. As an example, merchant 110 can incorporate price tags in HTTP headers, but it can be encoded in any protocol layer. These price tags are then intercepted and read by charging agent 112 or 113.

The price tag of the invention combines with data as a product (content) sold by merchant 110, e.g. content data, such as multi-media music or video, copyrighted books or articles, electronic coupons, participation in on-line games, stock price quotes, traffic reports, etc.

In other cases, the data may constitute a message from merchant 110 regarding a service/product. The service/product that is the subject of the message may be part of other data streams delivered earlier or later via communication network 108, or may be delivered by means other than communication network 108, such as through shipping. For example, the message can indicate the price for the requested service/product in a format that can be understood by customer 102 while the incorporated price tag is in a format that can be processed by charging agent 112 or 113. As another example the message can be a notice of credit for a returned product, which is directed to customer 102, while the incorporated price tag is in a format that can be processed by charging agent 112 or 113. Tho product could have been returned to merchant 110 via communication network 108, for example content data returned data to defects or fir a “used” price, or via other means such as shipping. Another example of a credit message can be related to advertisements, where in return for being willing to receive advertisements, customer 102 is credited. The credit can be related to a specific message, or as below just as part of a program of enabling commercials to be sent to customer 102.

It is also possible that the message is not in reference to a specific service/product. For example, merchant 110 may send a message indicating a volume discount for a valuable customer 102, which incorporates a price tag containing the discount (credit) to be processed by charging agent 112 or 113. As another example, the message may indicate a periodic fee for customer 102 and incorporate a price tag for the periodic fee, for example for a subscription to an online newspaper.

It should be understood that in some cases the price tag may be the message, i.e. the price tag as such may include sufficient information for processing by charging agent 112 or 113 without receiving additional information from merchant 110. For example merchant 110 may embed a price tag describing a volume discount in an HTTP header (which is data for IP and TCP purposes) and subsequently send the header with the incorporated price tag without sending any supplementary data regarding the discount.

It should also be evident that merchant 110 can send data incorporating price tags to a customer 102 which is intercepted by charging agent 112 or 113 or can direct the data to said charging agent. In some cases after being processed by the charging agent 112 or 113, the data may proceed to customer 102.

The price tag is in a format agreed upon by merchant 110 and the charging party, thereby ensuring that merchant 110 incorporates a price tag that can be processed by charging agent 112 or 113. In some preferred embodiments the format could have been developed by individual merchants 110 and charging parties for transactions involving those merchants 110 and customers 102 serviced by those charging parties. Alternatively and more preferably, the format could be based on standards developed by one or more industry groups, with merchants 110 and the charge parties agreeing to abide by those standards.

An example of a price tag 300 according to a preferred embodiment is illustrated in FIG. 3.

Price tag 300 includes at least a service/product identifier field 302, a merchant identifier field 304, and a price information field 308.

As an example service/product identifier field 302 can include the field title “Commerce-Product:” and a string representing the service/product name. Merchant identifier field 304 can include the field title “Commerce-Merchant:” and a string representing the name of merchant 110.

Price information field 308 typically includes two values, the amount and the currency, which in other embodiments might be embedded as separate fields.

As an example, price information field 302 can include the field title “Commerce-Price”, the amount, and the currency all separated by colons. The amount may be a number of up to ten-digits followed by a colon and a decimal point designator. The amount may include an optional minus sign. The amount when appropriate may be zero. The currency may be a three-letter representation of the currency according to ISO 4217 standards. Non-standard currencies, e.g. air minutes, airline miles, game tokens, etc. can be indicated, for example, by the symbols “x-” followed by at least three additional letters. Examples of non-standard currencies include x-AMIN, which represents air minutes with the charging party, and x-TOK, which represents special tokens used for credit or debit with the charging party. The representation of non-standard currencies should be agreed upon a priori by merchant 110 and the charging party. In some cases, the currency may be omitted. For example, if a particular merchant 110 only has US resident customers 102, the USD currency may in some cases be implicit.

Optionally a product vendor (product manufacturer) field 306 can be included in price tag 300. For example, product vendor field 306 can include the field title “Commerce-Vendor:” and a string representing the name of the vendor. As another option, the vendor name may be encoded in service/product identifier field 302.

Optionally, price tag 300 may include one or more optional other fields 310. For example, one other field 310 may be a category field in the form of “Commerce-category:” and a suing representing the category. The category field 310 can be used for example for pricing agreements between customers 102 and merchants 110 or between customers 102 and the charging party. For examples category field 310 can be used to identify a broadcast, which should be received only by particular customers 102. As another example category field 310 can be used to identify a broadcast whose charge varies for different customers 102.

A method for incorporating price tags in data and reading the incorporated price tags is illustrated in FIG. 4, according to a preferred embodiment of the present invention. It should be evident that the order of steps in FIG. 4 is for convenience of presentation and may be altered depending on the preferred embodiment.

In optional step 402, merchant 110 receives a request from customer 102 to purchase a service/product or receives a returned service/product from customer 102. For example, if merchant 110, in this example ‘SongsOnline’ hosts a multi-media web site, customer 102 equipped with a browser can send the uniform resource locator (URL) of the “downloading song” web page as the request. Step 402 may be skipped for example for volume discount or periodic fee messages. In optional step 403 merchant 110 authenticates charge agent 112 or 113 and/or customer 102 typically using a client side certificate provided by the charging party. This optional authentication for example guarantees that merchant 110 is sending the price tag to a valid agent 112 or 113 and that the charging party will reimburse merchant 110 when the transaction is complete, if necessary.

In step 404, merchant 110 incorporates a price tag in data, for example in an HTTP header, to be transmitted either to customer 102 or to charging agent 112 or 113. The price tag is incorporated for use by charging agent 112 or 113. The price tag can be, for example, in the format illustrated in FIG. 3. As an example, incorporating module 114 can use the data received in the request in step 402 and data stored in pricing database 124 in a merchant server to extract the pricing information and arrange the pricing information in the format of price tag 300.

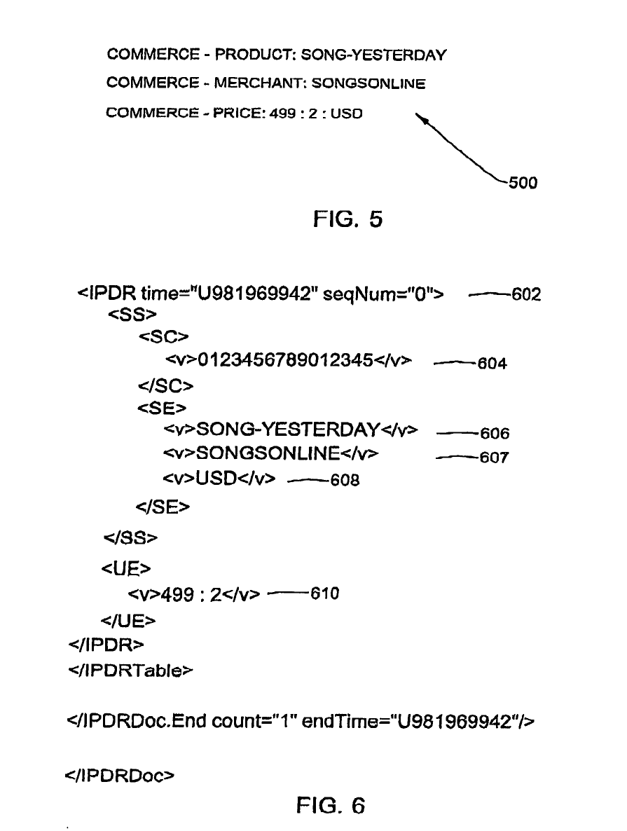

FIG. 5 shows an example 500 of price tag 300 for the song ‘Yesterday’, which is assumed to be offered by the company SongsOnline for USD4.99.

In step 406, charging agent 112 or 113 receives the transmitted data including the price tag. Charging agent 112 or 113 may intercept data directed to customer 102, for example by checking each data packet for an incorporated price tag, or for preferred embodiments where the price tag is encoded within the HTTP header by checking each header for a price tag. In other preferred embodiments, the data with the incorporated price tag may have been directed to charging agent 112 or 113 (fir example for periodic fees). As mentioned above, in preferred embodiments where at least reader 204 of charging agent 112 is included in communication device 104, reader 204 is positioned in communication device 104 in such a way that reader 204 can intercept every packet/header going to or from communication device 104. Reference is made to application Ser. No. 09/917,216 “Prepaid Communication System and Method” filed on Jul. 30, 2001 and assigned to the same assignee as the current invention, details of which are incorporated by reference. If charging agent 113 is embedded in the network infrastructure, charging agent 113 should be positioned on the path between merchant 110 and customer 102 so as to be able to intercept all traffic between these two entities 110 and 102.

In step 408 the price tag is read. It should be evident that as long as reader 204 is aware of the format used by merchant 110 for encoding price tags, reader 204 can extract the relevant values. Assuming the price tag is incorporated in HTTP headers, reader 204 reads the header. For example, reader 204 may parse the header and search for field titles indicating a price tag, such as “Commerce-Product:”, “Commerce-Merchant:” and “Commerce-Price:”, etc. Reader 204 then extracts the values (e.g. service/product name string, merchant name string, amount, currency, etc.) of these fields 302, 304, and 308 that follow the field titles. For a price tag incorporated in an HTTP header, the price tag fields are compatible with standard HTTP header fields and reader 204 may identify the price tag fields by parsing the HTTP header. If the header is to be passed on to a browser associated with communication device 104, reader 204 can remove the price tag fields from the header before the header is transferred to the browser but the removal is generally not necessary because the browser will typically ignore the fields that the browser does not recognize.

In order to record a charge or credit, charging agent 112 or 113 needs to be aware of or be made aware of at least the following aspects of the charge or credit: the charge or credit itself (i.e. amount and currency) which is received in step 406 and is read in step 408 and the identity of customer 102 whose account with the charging party is to be charged or credited. In the case of a non-zero debit, charging agent 112 or 113 may also need to actively investigate whether the account can support the debit (it is evident that the account can support a credit or a zero debit) and therefore charging agent 112 or 113 may need to access the account balance, balance due, credit rating, credit line and/or rules.

For each charge or credit, charging agent 112 or 113 determines in step 410 identification information of customer 102 (customer identification). The customer identification can be for example any communication network identification, used for any communication network layer (i.e. any protocol specific identifier) of communication network 108. The customer identification could as another example be another type of customer identification recognizable by charging agent 112 or 113. Examples of customer identification include: MSISDN, WAP proxy user identity, subscriber identity, global WAP client ID, IP address, cellular or PSTN telephone number, identification of the cellular phone, account number with charging party etc. If charging agent 113 is included in or coupled to the communication infrastructure, charging agent 113 can extract the customer identification from an intercepted message addressed to customer 102 or if the message is directed to charging agent 113, the message may include an identifier of customer 102. Alternatively, if at least part of charging agent 112 is included in or coupled to communication device 104 of customer 102, charging agent 112 may a-priori know the customer identification. It is also possible that in alternative preferred embodiments, price tag 300 is extended to include an identifier of customer 102.

Charging agent 112 or 113 evaluates if the account of customer 107 with the charging party can support the sum of money represented by the read price tag (step 412). If the sum of money is a credit or zero debit, it is assumed that the account can support the sum of money. If the sum of money is a debit, the evaluation is with reference to the account balance, balance due, credit rating, credit line and/or rules.

In some cases, charging agent 112 or 113 can receive via billing system 116 information from database 122, which cross-references the customer identification with the account balance, balance due, credit rating, credit line and/or rules. For example evaluator 210 of charging agent 112 or 113 may transfer a query over communication network 108 to billing system 116 inquiring about account information (for example balance, balance due, credit line, credit rating, and/or rules), billing system 116 then accessing database 122 to obtain the requested information which billing system 116 and transmitting the information via communication network 108 to evaluator 210.

Alternatively, in some cases where charging agent 112 is at least partially included in or coupled to the corresponding communication device 104 of the identified customer, charging agent 112 may instead access local memory 220 that stores the account balance, balance due, credit rating, credit line and/or rules.

If the account cannot support the debit, no charge is allowed and the individual purchase/service is denied or a continuing purchase (such as for example a subscription) is terminated (step 414). Preferably charging agent 112 or 113 indicates to both customer 102 and merchant 110 that the purchase has been denied/terminated (i.e. charge not allowed) in step 415.

Optionally, if the account of customer 102 can support the charge or credit, charging agent 112 or 113 submits the charge or credit for customer approval and receives the approval of customer 102 for the charge or credit in step 413. For example, charging agent 112 or 113 can transfer the information included in price tag 300 to customer 102 for customer approval. In some preferred embodiments step 413 might optionally include charging agent 112 or 113 authenticating customer 102 through biometric means and/or by customer 102 entering (by typing in or speaking) a secret key (password). Step 413 could be performed in other preferred embodiments prior to step 412 (i.e. first it is confirmed that the charge or credit is approved by customer 102 and then it is verified that the account can support the sum of money). In preferred embodiments including step 413, the remaining steps are only performed if the requested customer approval is received.

Alternatively, step 413 may be skipped, for example if charging agent 112 or 113 does not need to submit and receive customer approval. For example, particular customer 102 when establishing an account with the corresponding charging party may have given blanket approval for registering unlimited credits and zero debits and for registering non-zero debits up to a certain amount in the local currency and/or from a submitted list of merchants 110.

In step 416, the data or part of the data is in some cases allowed to pass through to customer 102. As mentioned above the price tag or some of the price tag fields may in some cases have been removed before the data is passed through to customer 102. Data may be passed through to customer 102 for example, if at least part of the received data is content data or if the received data includes a message for customer 102. In other cases step 416 may be skipped, for example if the received data is a message directed to charging agent 102.

In step 418 a record of the (allowed) charge or credit is generated by charging agent 112 or 113 (i.e. the charge or credit is registered). The record includes sufficient information for billing customer 102 for the recorded charges/credits (if the account is postpaid) and/or for settling accounts with merchant 110. Preferably the record includes the service/product description, merchant identification and price information read from the price tag, and an identification of customer 102. In some cases, charging agent 112 or 113 may include a conversion table (not shown) to convert a customer identification used by charging agent 112 or 113, which is unrecognizable by billing system 116, to a customer identification recognizable by billing system 116.

If necessary, conversion into the appropriate currency may be performed prior to evaluation step 412 or registering step 418.

FIG. 6 illustrates an example of a record generated by charging agent 112 or 113, according to a preferred embodiment of the current invention. For simplicity of drawing and discussion, the record shown in FIG. 6 omits some details that are typically present in records generated by charging agent 112 or 113, for example references for the schema used in the record. The illustrated record includes in section 602 the time that agent 112 or 113 began producing the record, and optionally, the sequence number, the version number and the type of record. Section 604 includes the customer identification, in this example the identification of the cellular telephone 0123456789012345. Section 606 includes the description of the service/product, in this example, Song-Yesterday Section 607 includes an identifier of merchant 110, here SongsOnline. Section 608 includes the currency, in this example United Stated Dollars. Section 610 includes the amount in the currency described above, in this example 4.99. In this example, the sequence number of the report is used to ensure correct synchronization between charging agent 112 or 113 and billing system 116. The amount is expressed in is example in the format of a number of up to ten-digits, colon and a decimal point designator. In this example the amount is positive but for a credit a minus sign would also be included.

In optional step 419, if the account balance or balance due is maintained locally, charging agent 112 updates the account balance or balance due in local memory 220 for the recorded charge or credit. Typically for prepaid accounts the balance is locally maintained and updated. If the balance or balance due is updated locally, the updates will be reported by charging agent 112 to billing system 116 at periodic intervals for auditing and balance recharge purposes.

In optional step 420, charging agent 112 or 113 confirms the recording of the charge or credit with merchant 110 and/or customer 102. For example, if the data is a message relating to a service/product, charging agent 112 or 113 may send a confirmation of the charge to merchant 110 so that merchant 110 can deliver the purchased service/product. As another example, charging agent 112 or 113 may provide a summary of the record (for example including service/product name, merchant name and price information) to customer 102.

In some preferred embodiments where the data is content data, there might be a sequence of communication between charging agent 112 or 113 and merchant 110 repeating steps 416 to 420 as more pieces of content are delivered to customer 102. In some other cases only if complete content is delivered, will the charge be recorded and if there was a failure to complete delivery the charge will be reversed.

In step 422, charging agent 112 or 113 sends the record of the charge or credit to billing system 116 via communication network 108. In some cases, the record may be sent along with other records after a predefined number of reports are accumulated, after a predefined period of time, or upon request of billing system 116. As mentioned above, the report is preferably transmitted using a secure protocol such as SSL/TLS, IPsec or WTLS. For preferred embodiments where communication device 104 is wireless and assuming charger 206 of charging agent 112 is included in or coupled to a wireless communication device 104, the report may be sent by agent 112 to a WAP gateway using the Wireless Session Protocol (WSP) and the gateway further converts the contents of the report to HTTP.

Billing system 116 receives the record(s) in step 424. If the account balance or balance due is maintained and updated by the billing system, then in optional step 425 billing system 116 updates the balance(s) and/or balance(s) due in database 122 for the charge(s)/credit(s) included in the record(s) received in step 424.

In optional step 426, billing system 116 bills customer 102 for the charge(s)/credit(s) included in the received record(s), preferably as part of the periodic billing for the account of customer 102 with charging party. It is possible that in some cases the recorded charges may not be fully billed for example if there are special rate agreements between customer 102 and the charging party. The debit(s)/credit(s) included in the record(s) can increase or decrease the total owed by customer 102 for the period. Billing for the account with charging party can involve any known procedure, for example sending a debit or credit note, direct payment from another account (for example a bank account), charging or crediting another account (for example a credit card account), etc. For a prepaid account step 426 may be skipped because collection was made in advance.

In optional step 428, merchant 110 is reimbursed for debits (related to merchant 110), which were registered in the account of customer 102 with charging party. In optional step 430, merchant 110 reimburses the charging party for any related credits registered in the account of customer 102 with the clog part. Steps 428 and/or 430 in some cases follow the billing by billing system 116 of merchant 110 (i.e. sending a credit or debit note) for amounts owed to or owed by merchant 110. Steps 428 and 430 together constitute a settling of debits/credits between the charging party and merchant 110. It should be evident, that steps 428 and 430 generally occur on an aggregated basis for all customer accounts with a particular charging party that involve a particular merchant 110. In some cases the charging party takes a commission for charging and collecting on behalf of merchant 110 and the charging party will credit the account of merchant 110 according to net owed after subtracting the commission.

It will also be understood that the system according to die invention may be a suitably programmed computer. Likewise, the invention, contemplates a computer program being readable by a computer for executing the method of the invention. The invention further contemplates a machine-readable memory tangibly embodying a program of instructions executable by the machine for executing the method of the invention.

While the invention bas been described with respect to a limited number of embodiments, it will be appreciated that many variations, modifications and other applications of the invention may be made.

1. A method for trading at least one service or product between a merchant and a customer, comprising:
the merchant, incorporating a price tag in data that relates to the tradable service or product and that is to be transmitted from the merchant to the customer, said price tag including price information for the at least one service or product and being incorporated in anticipation of the price information being registered if the trade is completed in a customer account with a network operator that provides access for the customer to a communication network;
transmitting said data via said communication network; and
the network operator or a charging utility associated therewith, intercepting said price tag and if the trade is completed, registering the price information in the customer account.

2. A method according to claim 1, wherein said price tag is formatted according to an acceptable standard.

3. The method of claim 1, further comprising prior to said incorporating: receiving a purchase request from the customer for the at least one service or product and the registration includes charging the customer account.

4. The method of claim 1, further comprising prior to said incorporating; receiving at least one product returned by the customer, and the registration includes crediting the customer account.

5. The method of claim 1, wherein said price tag also includes an identifier of the merchant.

6. The method of claim 1, wherein said price tag also includes a description of the at least one service or product

7. The method of claim 1, wherein said price information includes an amount and a currency for the at least one service or product.

8. The method of claim 1, wherein said price tag also includes an identifier of a manufacturer of the at least one product.

9. The method of claim 1, wherein said price tag also includes a category description.

10. The method of claim 1, wherein at least part of said data is an HTTP header and said price tag is incorporated in said header.

11. The method of claim 1, wherein at least pars of said data constitutes at least part of the at least one product.

12. The method of claim 11, wherein said data is a message regarding the at least one service or product.

13. A method for evaluating whether to allow a charge or a credit for at least one service or product in a trade between a merchant and a customer, comprising:
receiving data that relates to the traded service or product and that includes a price tag transmitted via a communication network said price tag including price information for the at least one service or product, and said price tag having been incorporated in said data in anticipation of said price information being charged or credited to a customer account with a network operator providing access for the customer to said communication network;
reading said price tag;
evaluating whether said customer account can support a charge or a credit for a sum of money represented by said price information; and
if said customer account cannot support said charge for said sum represented by said price information, not allowing said charge for said sum.

14. The method of claim 13, wherein said evaluating includes: checking locally stored information on said Homer account, wherein said information is at least one from a group including: account balance, balance due, credit rating, credit line, and account rules.

15. The method of claim 13, wherein said evaluating includes: transferring a query over said communication network to a separate server inquiring about information on said customer account, wherein said information is at least one from a group including account balance, account balance due, credit rating, credit line, and account rules.

16. The method of claim 13, further comprising:
if said charge is not allowed, indicating so to one or both of the merchant and the customer.

17. The method of claim 13, further comprising: if said customer account can support said charge or credit for said sum of money represented by said price tag, allowing and registering said charge or credit for said sum under said customer account.

18. The method of claim 17, wherein said registering includes: converting said sum into local currency.

19. The method of claim 17, wherein said registering is only performed if the customer approval for said charge or credit is previously requested and received.

20. The method of claim 17, fiber comprising: if said registering is performed, indicating to one or both of the merchant and the customer that a registering of said charge or credit is confirmed.

21. The method of claim 17, further comprising: setting said registered charge or credit with the merchant.

22. The method of claim 17, further comprising: if said registering is performed, allowing at least part of said data to pass through to the customer.

23. The method of claim 22, wherein at least part of said passed through data is content data

24. The method of claim 22, wherein at least part of said passed through data is a message for the customer.

25. A method for trading at least one service/product between a merchant and a customer, comprising:
the merchant, incorporating a price tag in data that relates to the tradable service or product and that is to be transmitted from the merchant to the customer, said price tag including price information for the at least one service or product and being incorporated in anticipation of the price information being registered if the trade is completed in a customer account with a network operator that provides access for the customer to a communication network;
transmitting said data via said communication network;
a charging agent associated with said network operator intercepting said price tag, and recording a charge or a credit according to said price information in said customer account;
a billing system associated with said network operator receiving the recorded charge or credit and settling said recorded charge or credit with the merchant.

26. A system for pricing a service or product tradable between a merchant and a customer, comprising:
an incorporator utility for incorporating a price tag in data that relates to the tradable service or product to be transmitted from the merchant to the customer through a communication network, said price tag including price information for the at least one service or product and being incorporated in anticipation of charging or crediting a customer account with a network operator that provides access for the customer to said communication network, the churging or crediting, being based on said price information and occurring if the trade is completed.

27. The system of claim 26, further comprising a pricing database including pricing information for use in said price tag.

28. A system for deciding whether to allow a charge for a service or product in a trade between a merchant and a customer, comprising:
a reader for intercepting and reading a price tag that is incorporated in data relating to the traded service or product, said data being transmitted via a communication network, said price tag including price information for the traded service or product and having been incorporated in said data in anticipation of charging or crediting a customer account with a network operator providing access for the customer to the communication network based on said price information; and
an evaluator for evaluating if said customer account can support a charge or a credit for a sum of money represented by said price information.

29. The system of claim 28, further comprising: a charger for recording said charge or credit to said account.

30. The system of claim 29, further comprising a business support system including a billing system for settling said recorded charge or credit with the merchant.

31. The system of claim 30, wherein said business support system also includes a database for storing information on said account.

32. The system of claim 28, further comprising: a currency converter for converting said price information into local currency.

33. The system of claim 28, wherein at least part of the system is included in or coupled to a communication device of the customer.

34. The system of claim 28, wherein at least part of the system is included in or coupled to a communication infrastructure of said network operator.

35. The system of claim 28, further comprising a local memory included in or coupled to a communication device of the customer or a charging agent associated with said network operator, for storing information on said account.

36. A method for selling content from a merchant of the content to a customer, comprising:
the merchant, incorporating a price tag in data that includes the content, said price tag including price information for said content and being incorporated in anticipation of the price information being charged to a customer account with a network operator that provides access for the customer to a communication network;
transmitting said data via said communication network; and
the network operator or a charging utility associated therewith, intercepting said price tag and if the sale is completed, registering the price information in the customer account.

37. The method according to claim 36, further comprising: determining whether said account can be charged for the price of said content and allowing transfer of said content to the customer based on such determination.

38. The method of claim 37, wherein the content is transferred to the customer only if the charge was previously submitted for customer approval and customer approval was received.
